(19) United States
(12) Patent Application Publication
(10) Pub. No.: US 2012/0102740 A1
(43) Pub. Date: May 3, 2012

(54) HULL FLOOR SUPPORT SYSTEM

(76) Inventor: Charles Preston Gros, White City, OR (US)

(21) Appl. No.: 12/916,817

(22) Filed: Nov. 1, 2010

(51) Int. Cl. B23P 17/00

(52) U.S. Cl. 29/897.2

(57) ABSTRACT

A method of making and installing a boat rib making a portion of a boat comprising the steps of: shearing a flat piece of metal to cut to a size; attaching the flat piece of metal to a moveable carriage; cutting apertures in the flat piece of metal; cut final outside dimensions in the flat piece of metal; bending said flat piece of metal to create a rib; and securing said rib to a floor.

### GOVERNMENT RIGHTS

This invention was not made with Government support. The Government does not have any rights in this invention.

### BACKGROUND OF THE INVENTION

Boat hulls may have stiffeners to keep shape of various portions, such as the bottom or hull of the boat.

The relevant art method of making the bottom of boats is clamping the bottom of the hull to a jig, and then welding stiffeners to the inside bottom. Once the jig is released from the bottom, the bottom stresses and strains created by the weld cause deformations in the bottom, which makes each bottom different, which reduces shape and structural consistency.

What is needed is a method of assembling a bottom of a boat of bottom of a hull to create a consistent structure, with consistent tension and compression forces throughout. What is also needed is a method of using ribs to give and provide the shape to a bottom, and to provide strength, without using jigs. What is also needed is a method to create or provide the shape of the boat hull. The ribs may also prevent deformation of the hull. Also, a rib that provides support for a full level floor is needed.

### BRIEF SUMMARY OF THE INVENTION

One aspect of the present invention is a method of making a portion of a boat (100), comprising the steps of: shearing a flat piece of metal to cut to a size (300); attaching said flat piece of metal to a moveable carriage (400); cutting apertures in said flat piece of metal (500); cut final outside dimensions in said flat piece of metal (600); bending said flat piece of metal to create a rib (700); and securing said rib to the floor (800).

These and other features, aspects and advantages of the present invention will become better understood with reference to the following drawings, description and claims.

### BRIEF DESCRIPTION OF THE DRAWINGS

FIG. 1 is a pictorial of one embodiment of the steps involved in the process or method of the present invention.

FIG. 2 is a pictorial view of one embodiment of a rib made with the process of the present invention;

FIG. 3 is a pictorial view of the rib, inside hull bottom, and floor;

FIG. 4 is a pictorial view of an embodiment of the ribs secured to the hull;

FIG. 5 illustrates a pictorial of a sectional view of the rib, floor, and hull bottom; and

FIG. 6 illustrates an embodiment of the floor.

### DETAILED DESCRIPTION OF THE INVENTION

The following detailed description is of the best currently contemplated modes of carrying out the invention. The description is not to be taken in a limiting sense, but is made merely for illustrating the general principles of the invention, since the scope of the invention is best defined by the appended claims.

### REFERENCE NUMERALS

10 hull floor support system
20 rib
22 rib first portion
24 rib second portion
26 bottom edge
30 inside bottom of boat hull
40 floor
50 rib aperture
60 rib end
100 method of making a portion of a boat
200 obtaining a flat piece of metal
300 shearing said flat piece of metal to cut to a size
400 clamping said flat piece of metal to a moveable carriage
500 cutting apertures in said flat piece of metal (reduce weight)
600 cut final outside dimensions in said flat piece of metal
700 bending said flat piece of metal (longitudinally, stiffener, helps keep shape) to create a rib
800 welding said rib to a floor

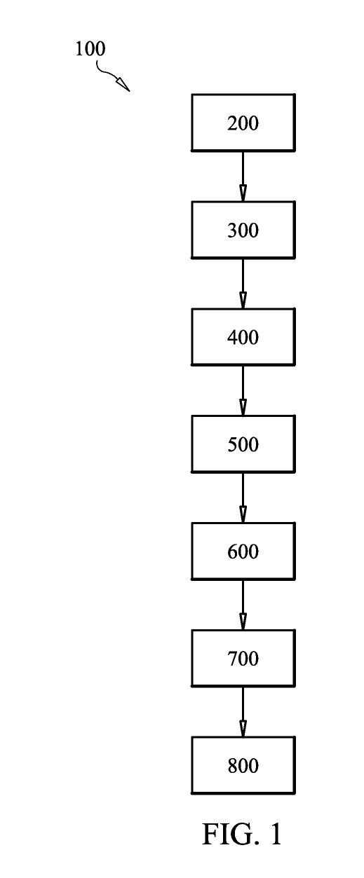

FIG. 1 illustrates one embodiment on the present invention 10, which is a method of making a portion of a boat 100, such as a bottom of a boat. FIG. 1 includes a first step of obtaining a flat piece of metal 200, followed by shearing said flat piece of metal to cut to a size 300, clamping said flat piece of metal to a moveable carriage 400, cutting apertures in said flat piece of metal (reduce weight) 500, cut final outside dimensions in said flat piece of metal 600, bending said flat piece of metal (longitudinally, stiffener, helps keep shape) to create a rib 700, and welding said rib to the floor 800.

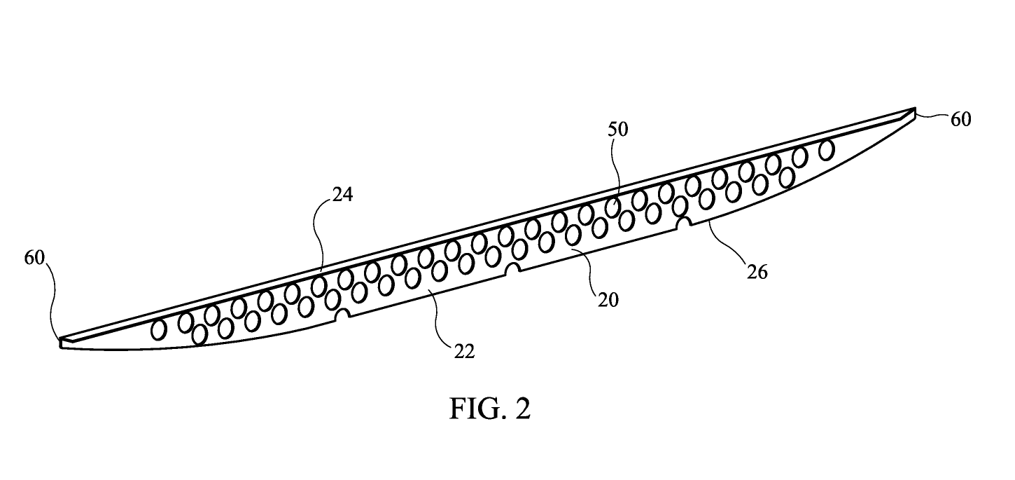

FIG. 2 illustrates an embodiment of a rib that may be created from the method 100 of FIG. 1. The rib 20 may have a rib first portion 22 that has a bottom edge 26 that may be curved so that it has a greater height at the middle than compared with the ends 60, such as the front or rear end 60. The rib 20 may have a rib second portion 24 that is oriented at a different angle than the rib first portion 22. The rib first portion 22 may have a rib aperture 50 therein. The rib aperture 50 may be created by the cutting step 500.

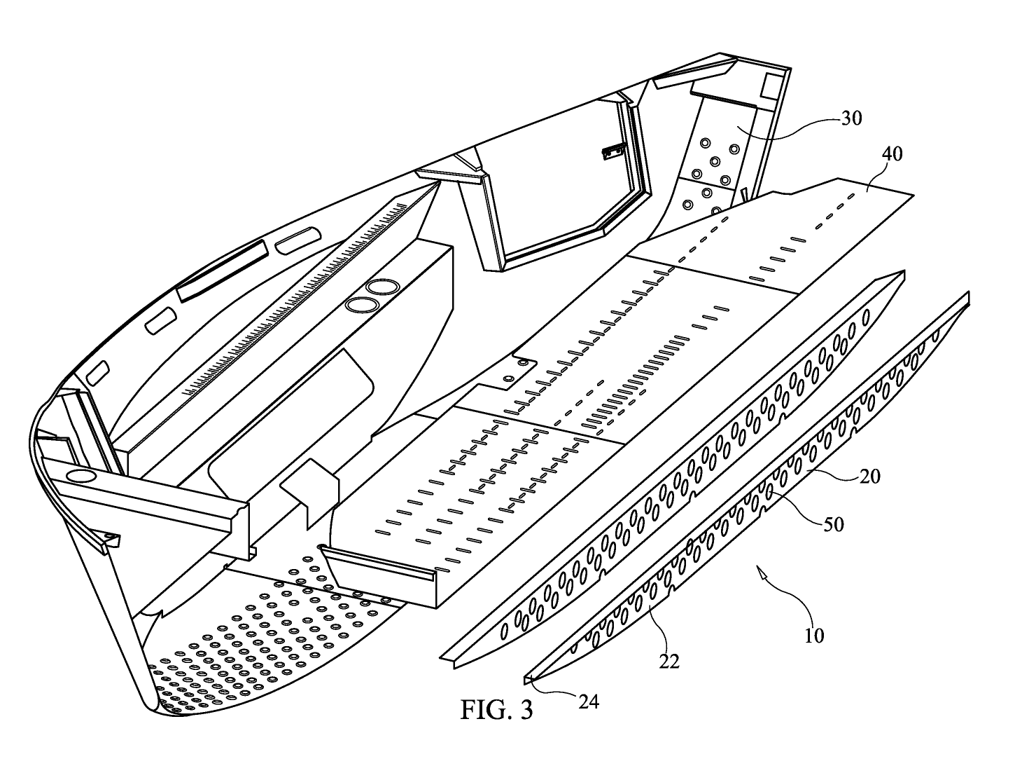

FIG. 3 illustrates the hull floor support system 10 with the rib 20. The angle 70 between the rib first portion 22 and the rib second portion 24 is also illustrated. The boat has a hull 30 and a floor 40.

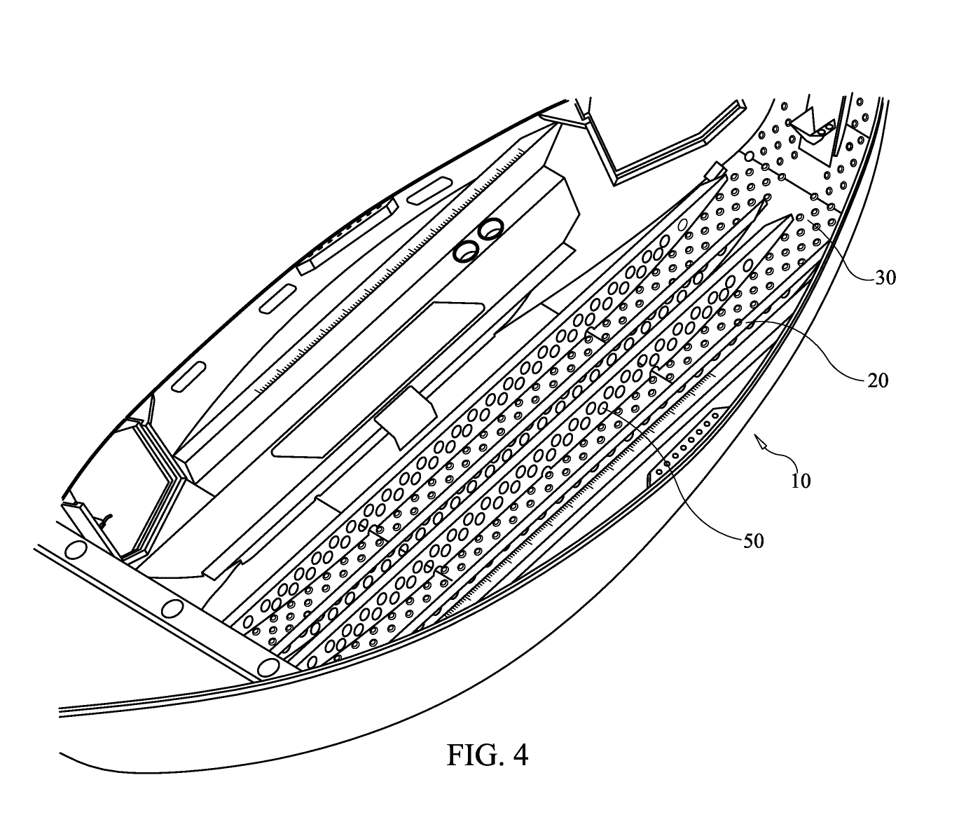

FIG. 4 illustrates an embodiment of a rib 20 that is secured to the inside bottom of the boat hull 30.

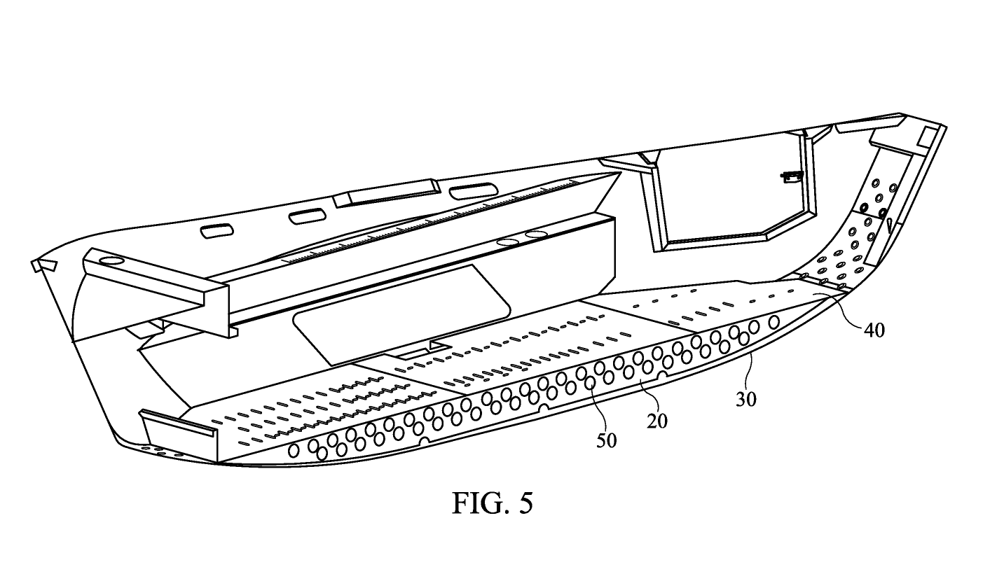

FIG. 5 illustrates an embodiment of the present invention showing that the rib 20 is disposed upwardly from the inside bottom of the hull 30, and also illustrates that the boat floor 40 is disposed upwardly from the boat rib 20.

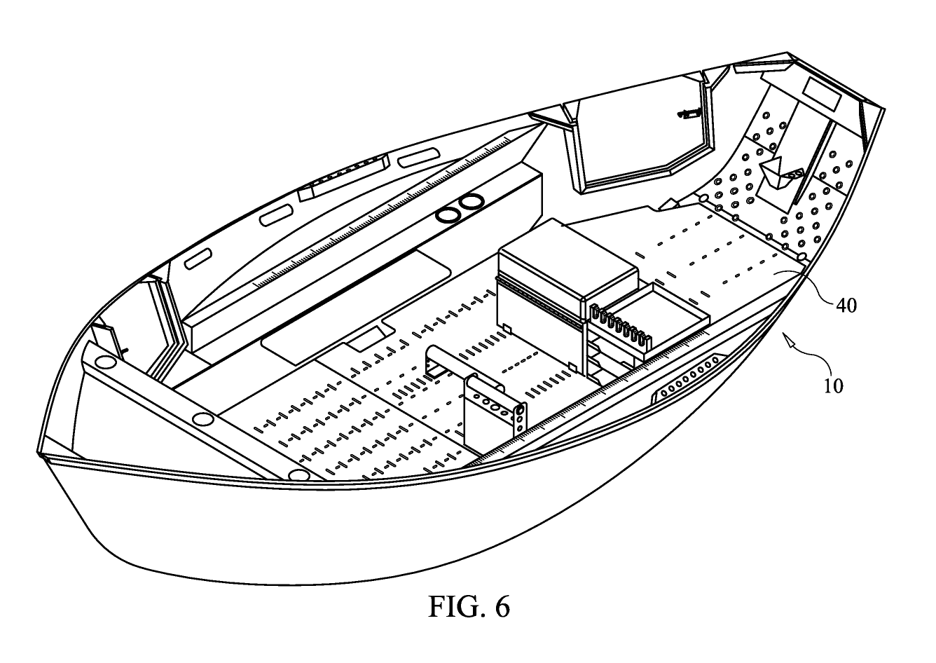

FIG. 6 illustrates one embodiment of the present invention showing the floor 40 above the ribs 20.

In one embodiment of the present invention, the ribs are aluminum having a thickness of about 0.118 inches.

I claim:

1. A method of making a portion of a boat (100), comprising the steps of:
shearing a flat piece of metal to cut to a size (300);
attaching said flat piece of metal to a moveable carriage (400);
cutting apertures in said flat piece of metal (500);
cut final outside dimensions in said flat piece of metal (600);
bending said flat piece of metal to create a rib (700); and
securing said rib to a floor (800).

2. The method of claim 1, further comprising the steps of:
obtaining a flat piece of metal (200) before the shearing step (300).

3. The method of claim 1, wherein said securing step (800) is performed by welding.

4. The method of claim 1, wherein said attaching step (400) is performed by clamping said flat piece of metal to the carriage.
